(19) United States
(12) Patent Application Publication
(10) Pub. No.: US 2019/0228458 A1
(43) Pub. Date: Jul. 25, 2019

(54) COMBINING ORDERS FROM MULTIPLE CUSTOMERS TO A SELLER IN E-COMMERCE

(71) Applicant: International Business Machines Coporation, Armonk, NY (US)

(72) Inventors: Gregory J. Boss, Saginaw, MI (US); Bernadette Pierson, South Hero, VT (US); Cesar Augusto Rodriguez Bravo, Alajuela (CR); Jayashree Vaidyanathan, Cincinnati, OH (US)

(21) Appl. No.: 15/875,439

(22) Filed: Jan. 19, 2018

(51) Int. Cl. G06Q 30/06; G06Q 10/08

(52) U.S. Cl. CPC G06Q 30/0635; G06Q 10/0836; G06Q 30/0639

(57) ABSTRACT

A method to aggregate orders in order to achieve benefits such as sharing or avoiding shipping costs from e-commerce merchants by combining orders being delivered to friends or addresses in neighboring locations or temporary pickup locations.

### BACKGROUND

The present invention relates to e-commerce methods, and more specifically to methods of facilitating sales by a seller in e-commerce to multiple customers.

E-commerce merchants often offer attractive prices on merchandise, but shipping costs often invalidate savings. For example, referring to FIG. 2, a potential customer 22b may be interested in a $7.00 flashlight, but the shipping and handling fee imposed by the merchant for an order might be $10.00. The customer might be reluctant to pay as much or more to ship an item than the item itself costs.

Other customers nearby, say customers 22c and 22d, might also be shopping at the same time—perhaps customer 22c wants a $12.00 hammer and customer 22d needs a lock set priced at $20.00. All of these customers face the same decision—should they buy the product, when the cost of shipping the product is a significant portion of the cost of the product (or even more than the cost of the product).

In order to encourage customers to place larger orders, some merchants have minimum order amounts to qualify for free shipping. For example, the merchant in this example might have set the minimum order amount to qualify for free shipping minimum to be $25.00. This might work well for customer 22d who wants to the $20.00 lock set, since by buying a box of drywall anchors for $5.00 he can save $10.00 in shipping, and his total cost for the order would be $5.00 less than if he hadn't bought the anchors. On the other hand, customer 22b would not be likely to want to find another $18.00 in goods he doesn't really want just to save $10.00 in shipping and handling, and the same probably also applies to customer 22c with his $12.00 order, who would have to spend $13.00 to save $10.00. Thus, the merchant is most likely to lose the orders from customers 22b and 22c at the very least.

### SUMMARY

According to one embodiment of the present invention, a method for a merchant computer combining online orders from a plurality of customers is disclosed. The method comprising the steps of: the merchant computer accepting a provisional order from a customer at a shipping address; the merchant computer searching for provisional orders from other customers which are eligible for combination with the provisional order from the customer at the shipping address; the merchant computer combining the provisional order from the customer at the shipping address with at least one provisional order from at least one other customers which are eligible for combination into a combined order; and the merchant computer sending an instruction to ship the items in the combined order.

According to another embodiment of the present invention, a computer program product for a merchant computer combining online orders from a plurality of customers is disclosed. The merchant computer comprising at least one processor, one or more memories, one or more computer readable storage media, the computer program product comprising a computer readable storage medium having program instructions embodied therewith. The program instructions executable by the merchant computer to perform a method comprising: accepting, by the merchant computer, a provisional order from a customer at a shipping address; searching, by the merchant computer, for provisional orders from other customers which are eligible for combination with the provisional order from the customer at the shipping address; combining, by the merchant computer, the provisional order from the customer at the shipping address with at least one provisional order from at least one other customers which are eligible for combination into a combined order; and shipping, by the merchant computer, the items in the combined order.

According to another embodiment of the present invention, a computer system for a merchant computer combining online orders from a plurality of customers is disclosed. The computer system comprising a merchant computer comprising at least one processor, one or more memories, one or more computer readable storage media having program instructions executable by the merchant computer to perform the program instructions comprising: accepting, by the merchant computer, a provisional order from a customer at a shipping address; searching, by the merchant computer, for provisional orders from other customers which are eligible for combination with the provisional order from the customer at the shipping address; combining, by the merchant computer, the provisional order from the customer at the shipping address with at least one provisional order from at least one other customers which are eligible for combination into a combined order; and shipping, by the merchant computer, the items in the combined order.

### BRIEF DESCRIPTION OF THE DRAWINGS

FIG. 1 depicts an exemplary diagram of a possible data processing environment in which illustrative embodiments may be implemented.

FIG. 2 shows a map of an example geographic area.

FIG. 3 shows a flowchart of the method.

FIG. 4 illustrates internal and external components of a client computer and a server computer in which illustrative embodiments may be implemented.

### DETAILED DESCRIPTION

A system and a method for aggregating orders going to the same seller based on proximity of the ship-to addresses. This enables sellers to increase their revenue by attracting non-critical purchases, and reducing or eliminating buyer procrastination and possible change of mind on purchases.

For a buyer, this system is a great money-saver for day-to-day purchases, allowing a buyer to purchase a non-critical item sooner, and to avoid shipping costs for critical items.

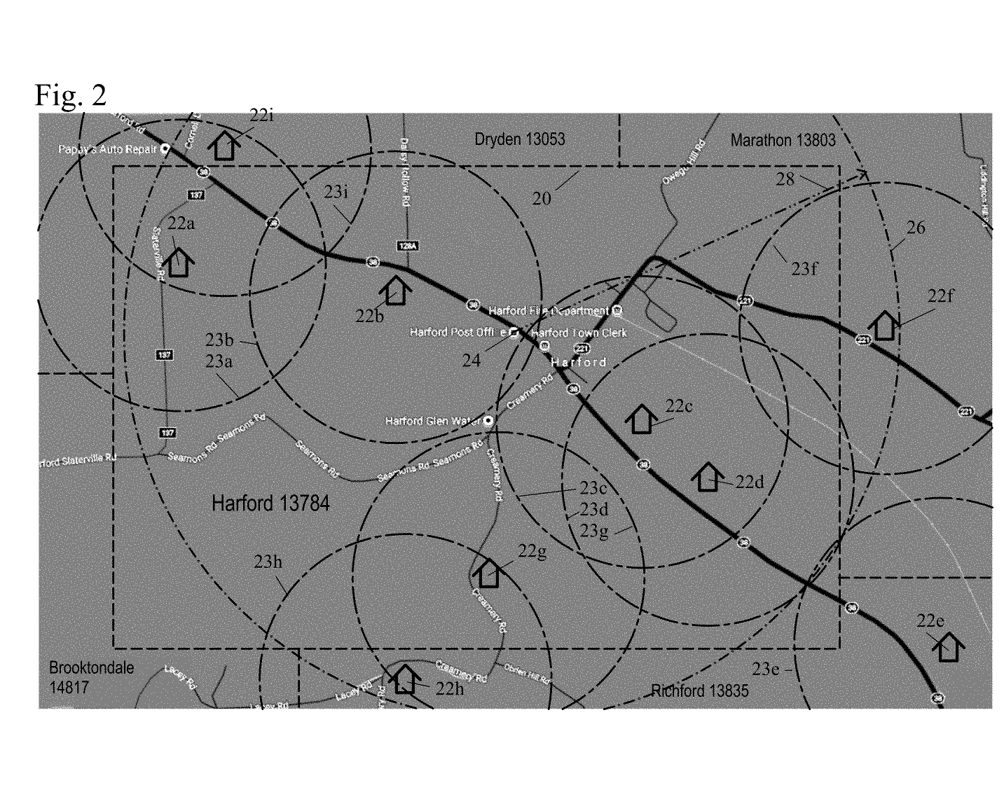

FIG. 2 shows a map of an example geographical area, in this case, a part of the town of Harford, N.Y. It will be understood that the figure is for example purposes only, and does not represent the actual geographic boundaries or locations of any actual persons or locations.

As is common in many rural areas, Harford is divided between a number of ZIP codes, depending on which post office services delivers in an area. The area immediately around Harford village is ZIP code 13784, denoted by the dashed line 20. Surrounding this, as indicated on the figure, are other ZIP code delivery areas such as Dryden 13053, Marathon 13803, Richford 13835 and Brooktondale 14817. A dash-dotted line 26 indicates the area which is within a selected radius 28 of the Harford Post Office 24 —for the purposes of this example, considered to be 3.5 kilometers (2 miles).

It will be understood that the term ZIP code, as used herein, is intended to refer not just to the US Postal Service's five-digit Zoning Improvement Program (ZIP) Codes or the extended nine-digit ZIP+4 codes, but also to other postal coding methods such as the postal codes used in the UK and Canada and other countries. The term may also refer to other systems for location coding such as the Geographic Locator Codes (GLC) used by US Federal agencies, latitude/longitude, the Maidenhead Locator System, What3Words codes, or any other such geographical location system.

A number of potential customers are indicated on the map as house icons 22a-22i. A short-long dashed circle 23a-23i indicates an area of, say, one-mile radius around each of the customers 22a-22i, respectively.

For the purposes of this example, suppose that the customers 22a-22i are all online, considering ordering goods from a merchant. Table 1, below, provides some information which will be used in the following example.

TABLE 1
Information for Example of FIG. 2

| | | KM from | Within | | | |
|---|---|---|---|---|---|---|
| Cus- | ZIP | Harford | one | Pur- | Ship- | |
| tomer | Code | PO | Mile | chase | ping | Total |
| 22a | 13784 | 3.0 | 22i | $7.00 | $10.00 | $17.00 |
| 22b | 13784 | 1.4 | — | $12.00 | $10.00 | $22.00 |
| 22c | 13784 | 1.5 | 22d | $20.00 | $10.00 | $30.00 |
| 22d | 13784 | 2.2 | 22c | $10.00 | $10.00 | $20.00 |
| 22e | 13835 | 5.0 | — | $22.00 | $10.00 | $32.00 |
| 22f | 13803 | 3.5 | — | $14.00 | $10.00 | $24.00 |
| 22g | 13784 | 2.3 | 22h | $8.00 | $10.00 | $18.00 |
| 22h | 13835 | 3.5 | 22g | $6.00 | $10.00 | $16.00 |
| 22i | 13053 | 3.2 | 22a | $18.00 | $10.00 | $28.00 |

As can be seen from Table 1, none of the customers qualifies for free shipping, since none of the purchases exceeds $25.00. Customers 22c and 22e would be likely to order something extra to complete their orders, since by adding an extra item costing $5.00 or $3.00, respectively, they would save $5.00 or $7.00 on their overall order cost. The other customers, on the other hand, would probably not complete their orders and the merchant would lose their business.

However, suppose customers were permitted to combine their orders with orders from other “nearby” customers who meet certain proximity criteria. In that case, the combined orders might exceed the $25.00 minimum and the shipping fee would be waived. The proximity criteria to determine which customers are “nearby” could be based on their addresses being within a radial distance threshold of each other, or within the same ZIP code, or within a given radius of a central shipping point such as a post office or store.

Using the example of FIG. 2 and Table 1, suppose the merchant was to establish a rule permitting customers who are within one mile of each other to combine their orders. Looking on the figure, it can be see that customer 22a and 22i are within each other's' one-mile circles 23a and 23i, respectively. Since customer 22a is spending $7.00 and 22i is spending $18.00, their combined order would be $25.00. Other customers who could combine orders under the “one mile radius rule” would be 22d and 22e (combined total $30.00) and 22g and 22h (combined total $14.00). Using this rule, then, customers 22a and 22i could take advantage of free shipping, as could customers 22d and 22e. They would be likely to do this and place their orders, and the merchant would gain $55.00 in orders which would probably have not have been placed. Customers 22g and 22h would still be under the free shipping minimum, and will probably not place their orders.

As an alternative, suppose the merchant were to permit customers who are within the same ZIP code to combine their orders. The merchant might choose to require any customers who took advantage of this rule to pick up their purchase at the post office serving that ZIP code, which would save costs for the merchant by allowing it to ship to the post office instead of individually to each customer, or the merchant could choose to ship directly to the customer as it would if the individual orders had all exceeded the minimum. Under this rule, customers 22a-22d and 22g could combine orders, as they all live in Harford ZIP code 13784. Their combined order would be $57.00, and they would easily qualify for free shipping. Customers 22e and 22h could also combine orders, since they live in the Richford 13835 ZIP code area, and with a total of $28.00, they, too would qualify for free shipping. The merchant would have gained $85.00 in business which might not have been placed otherwise (or at least $43, if customers 22c and 22e would have placed their orders anyway). Customers 22f and 22i, being the only customers in ZIP codes 13803 and 13053, respectively, would be ineligible to combine orders.

As another alternative, suppose the merchant were to permit customers who are within a specified distance of a central order pick-up location to combine their orders. The merchant would then be able to achieve savings by shipping the combined orders to the central location in one shipment, and each of the customers would drive there to pick up their portion of the combined order. For the purposes of this example, this could be defined as a radius of 3.5 kilometers/2 miles of the nearest Post Office, or of some commercial service operated by United Parcel Service (UPS), or of a retail location such as a big-box store or supermarket. Under this rule, if the Harford Post Office 24 were a pick-up point, all of the customers on FIG. 2, except customer 22e, could combine orders, as they are all within a 3.5 KM radius 28 of that location as indicated by the circle 26. Their combined order would be $95.00, and they would easily qualify for free shipping. The merchant would have gained $95.00 in business which might not have been placed otherwise (or at least $75, if customer 22c would have placed his order anyway). Customer 22e lives 5 KM from the Post Office, so he would not be eligible to combine orders, but since he's only three dollars short of the minimum he would probably find something small to add to his basic order and would place the order in any case.

The method and system of an embodiment of the present invention is beneficial to buyers as it would save money—imagine a large group of students in college dorms, or a group of suburban neighbors. The method and system of an embodiment of the present invention is beneficial to e-commerce sellers as it allows buyers to easily meet free-shipping minimums by aggregating orders, and makes it more likely for buyers to place non-emergency/non-critical orders, thereby increasing revenue. The system provides benefits including: potential money savings (such as free shipping or bulk discounts), or ease of ordering, or finding sellers who offer bulk discounts. The seller allows its customers to opt-in to combine orders to circumvent free shipping minimums.

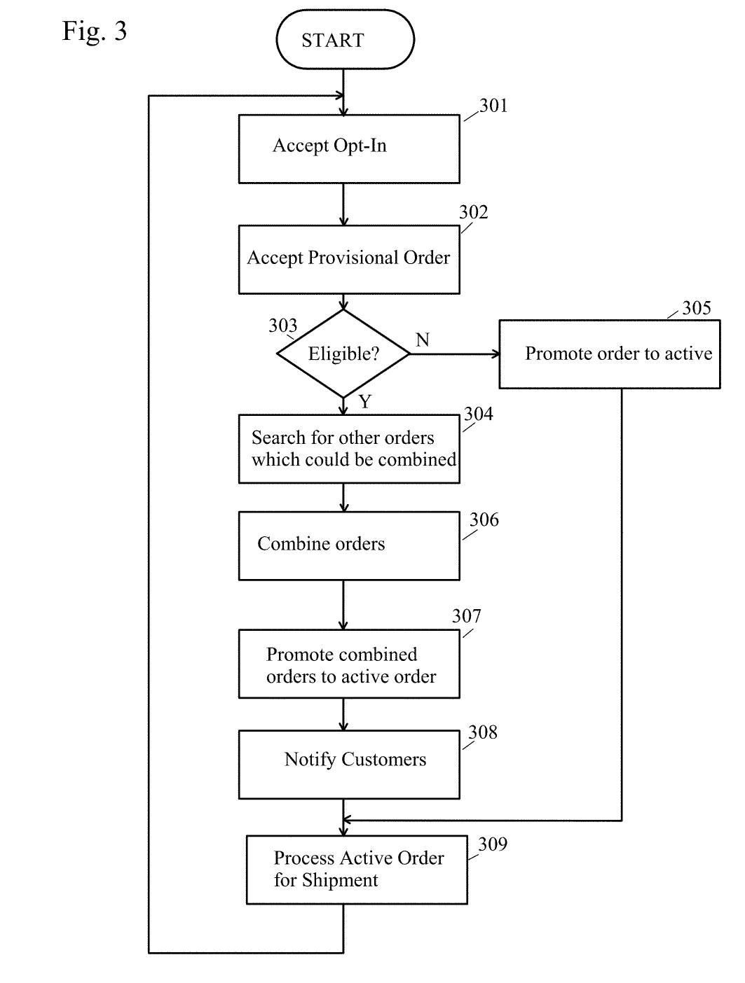

FIG. 3 shows a flowchart of the method.

Step 301: Accept Customer Opt-in: Each customer who chooses to opt-in will indicate their desire to participate in the order-combining program. Optionally, the customer may specify a ZIP code and a radius within the ZIP code where they are willing to get items shipped. The customer may also specify whether they are willing to use their shipping address for items ordered by other customers.

Step 302: Accept a provisional order from a customer. At the time of order entry, the customer may specify one or more of the following parameters:

a. a location for pickup (for example, by their front door, at a central location, etc.)

b. specify a time frame for pickup (next day, no later than a week, etc.)

c. automatically purchase items in the cart without concern for shipping or order combination (i.e. ignore order combination, the order is needed critically, so send it right away).

d. a designated time frame for an order to be placed if no combination of orders appears possible (a few hours, a day, a week, etc.).

e. an identification of items eligible for this method, or threshold amounts for eligibility—for example, a customer could specify that this method is only applicable to items within a certain price range;

f. selective opt-out of the order-combination method, possibly for specific items on the order. For example, the customer could also specify that they do not want to combine orders with other customers if their own order exceeded a certain amount, for example if the order is large enough, the customer might qualify for free shipping on his own and might not want to get involved in combinations with other, smaller, orders for other customers.

Step 303: Determine that the provisional order is eligible for order combination, based on the parameters entered in steps 301 and 302. The merchant could also choose to exclude certain items from this method such as items exceeding a certain price amount, fragile items or electronics items, etc. The merchant could also condition participation to allow combining orders based on the warehouse shipping location, or warehouse shipping locations within a certain radius.

Step 304: If the provisional order is eligible for order combination, the merchant system searches for provisional customer orders which might be eligible for combinations. For each provisional order pending on the system, the system looks at the ship to address and searches for other provisional orders which have shipping addresses which match under the order-combining eligibility criteria as explained above. This could be done immediately in real-time when an order is received, or, alternatively, the system could run a batch program on a determined schedule, for example, every few hours, that checks for possible orders which could be combined with other orders.

Step 305: If the provisional order is not eligible for combination, it is promoted to active and processed normally (Step 309)

Step 306: If system determines a match under the thresholds defined in step 304, then the provisional orders which match are combined.

Step 307: The combined orders are promoted from provisional orders to active orders.

Step 308: Depending on the opt-in customers' preferences, the system may notify the customers that their order has been combined with one or more orders of other customers, providing the shipping address where the order will be delivered and if necessary, the applicable timeframe when they can pick up their items.

Step 309: The system processes the active order for shipment as it would with any order which was placed.

The system then loops back to accept more instructions from customers (step 301).

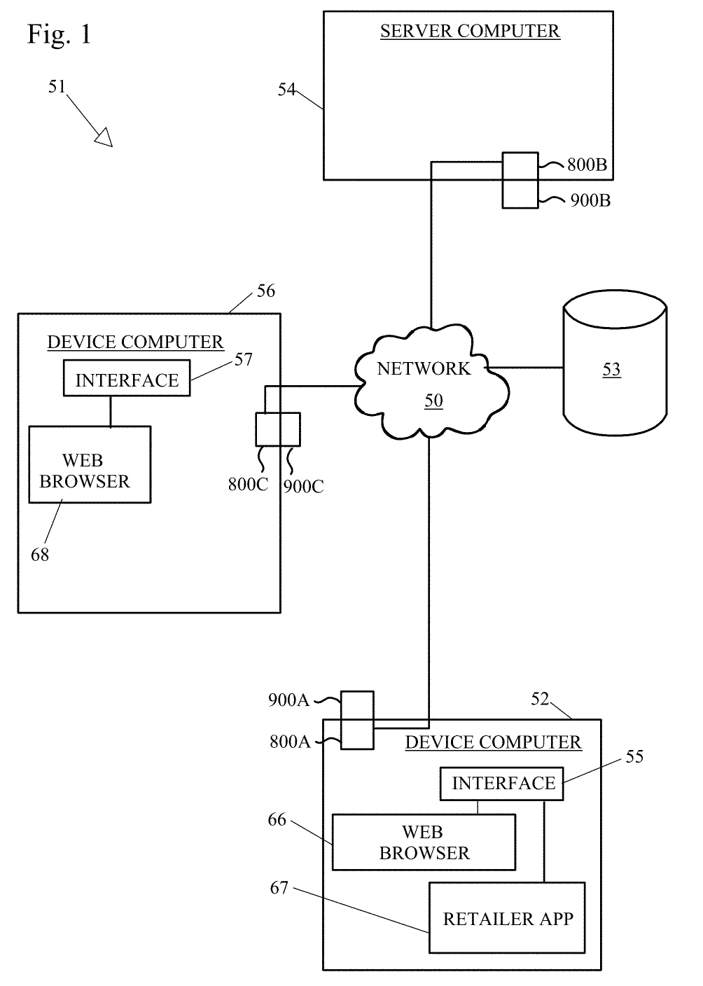

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computers 52 and 56, a repository 53, and a server computer 54 connect to network 50. In other exemplary embodiments, network data processing system 51 may include additional client or device computers, storage devices or repositories, server computers, and other devices not shown.

The device computers 52 and 56 may contain an interface 55 and 57, which may accept commands and data entry from a user. The commands may be regarding placing an order. The interface can be, for example, a command line interface, a graphical user interface (GUI), a natural user interface (NUI) or a touch user interface (TUI). The device computer 52 and 56 preferably include a web browser program 66 and 68. In device computer 52, which might be a smartphone or tablet or other portable computer, there could also be an application provided by the merchant (retailer app 67) which is specifically dedicated to functions specific to the merchant, such as placing provisional orders subject to the method.

While not shown, it may be desirable to have the web browser program 66 be present on the server computer 54. The device computer 52 includes a set of internal components 800a and a set of external components 900a.

Server computer 54 includes a set of internal components 800b and a set of external components 900b. In the depicted example, server computer 54 provides information, such as boot files, operating system images, and applications to the device computer 52. Server computer 54 can compute the information locally or extract the information from other computers on network 50.

Program code and programs such as web browser program 66, 68 and retail app program 67 may be stored on one or more computer-readable tangible storage devices or on one or more portable computer-readable tangible storage devices, or may be downloaded to a device computers 52, 56 or server computer 54 as needed for use. For example, program code and programs such as web browser program 66, 68 and retail app program 67 may be stored on at least one of one or more storage devices on server computer 54 and downloaded to device computer 52, 56 over network 50 for use. Alternatively, server computer 54 can be a web server, and the program code, and programs such as web browser program 66, 68 and retail app program 67 may be stored on at least one of the one or more storage devices on server computer 54 and accessed by device computers 52, 56. In other exemplary embodiments, the program code, and programs such as web browser program 66, 68 and retail app program 67 may be stored on at least one of one or more computer-readable storage devices on device computers 52, 56 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

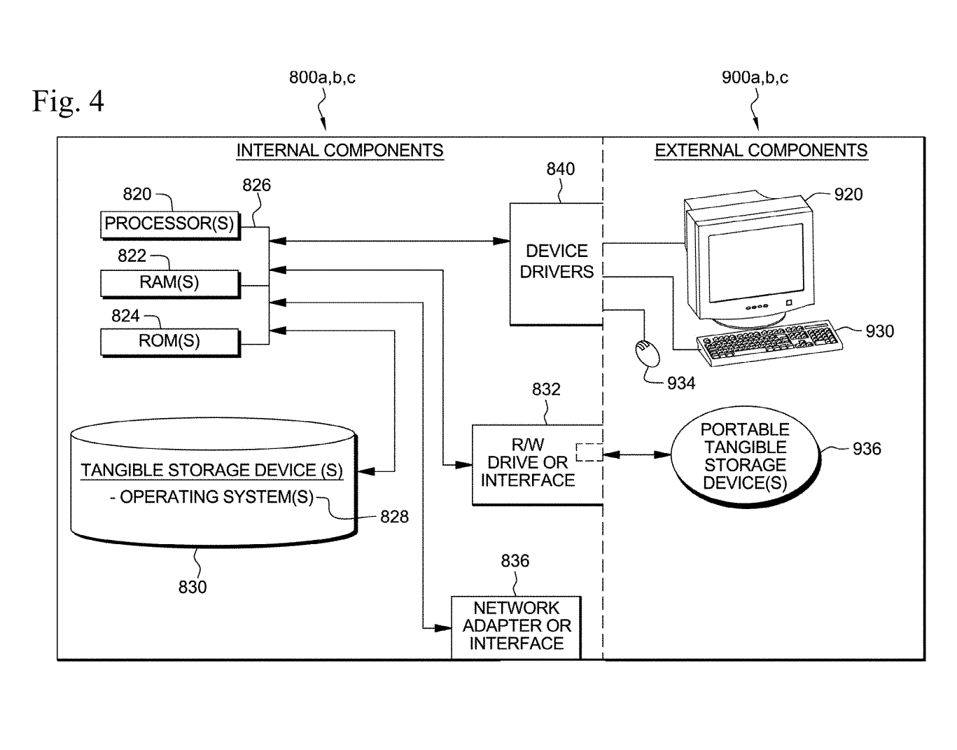

FIG. 4 illustrates internal and external components of device computers 52, 56 and server computer 54 in which illustrative embodiments may be implemented. In FIG. 1, a device computer 52, 56 and a server computer 54 include respective sets of internal components 800a, 800b, 800c and external components 900a, 900b, 900c. Each of the sets of internal components 800a, 800b, 800c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and web browser program 66, 68 and retail app program 67 are stored on one or more of the computer-readable tangible storage devices 830 for execution by one or more of the processors 820 via one or more of the RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b, 800c also includes a R/W drive or interface 832 to read from and write to one or more portable computer-readable tangible storage devices 936 such as a CD-ROM, DVD, memory stick, magnetic tape, magnetic disk, optical disk or semiconductor storage device. Web browser program 66, 68 and retail app program 67 can be stored on one or more of the portable computer-readable tangible storage devices 936, read via R/W drive or interface 832 and loaded into hard drive 830.

Each set of internal components 800a, 800b, 800c also includes a network adapter or interface 836 such as a TCP/IP adapter card. Web browser program 66, 68 and retail app program 67 can be downloaded to the device computers 52, 56 and server computer 54 from an external computer via a network (for example, the Internet, a local area network or other, wide area network) and network adapter or interface 836. From the network adapter or interface 836, web browser program 66, 68 and retail app program 67 is loaded into hard drive 830. Web browser program 66, 68 and retail app program 67 can be downloaded to the server computer 54 from an external computer via a network (for example, the Internet, a local area network or other, wide area network) and network adapter or interface 836. From the network adapter or interface 836, web browser program 66, 68 and retail app program 67 is loaded into hard drive 830. The network may comprise copper wires, optical fibers, wireless transmission, routers, firewalls, switches, gateway computers and/or edge servers.

Each of the sets of external components 900a, 900b, 900c includes a computer display monitor 920, a keyboard 930, and a computer mouse 934. Each of the sets of internal components 800a, 800b, 800c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Web browser program 66, 68 and retail app program 67 can be written in various programming languages including low-level, high-level, object-oriented or non object-oriented languages. Alternatively, the functions of web browser program 66, 68 and retail app program 67 can be implemented in whole or in part by computer circuits and other hardware (not shown).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for a merchant computer combining online orders from a plurality of customers, comprising the steps of:
the merchant computer accepting a provisional order from a customer at a shipping address;
the merchant computer searching for provisional orders from other customers which are eligible for combination with the provisional order from the customer at the shipping address;
the merchant computer combining the provisional order from the customer at the shipping address with at least one provisional order from at least one other customers which are eligible for combination into a combined order; and
the merchant computer sending an instruction to ship the items in the combined order.

2. The method of claim 1, further comprising the step of the merchant computer accepting an opt-in from a customer, indicating that the customer desires to participate in the method.

3. The method of claim 2, in which the opt-in includes a ZIP code and a radius within the zip code where the customer is willing to receive items shipped.

4. The method of claim 2, in which the opt-in includes an indication by the customer whether the customer is willing to use the customer's shipping address for items ordered by other customers.

5. The method of claim 1, wherein the step of the merchant computer accepting the provisional order from a customer, further comprises the merchant computer accepting a location for order pickup.

6. The method of claim 1, wherein the step of the merchant computer accepting the provisional order from a customer further comprises the merchant computer accepting a time frame for order pickup.

7. The method of claim 1, wherein the step of the merchant computer accepting the provisional order from a customer further comprises the merchant computer accepting a designated time frame for an order to be placed if no combination of orders appears possible.

8. The method of claim 1, further comprising the step, after the step of the merchant computer accepting the provisional order, of the merchant computer determining that the provisional order is eligible for order combination.

9. The method of claim 1, in which the step of the merchant computer searching for provisional orders from other customers is performed as a batch program on a determined schedule.

10. The method of claim 1, further comprising the step of the merchant computer notifying the customer at the shipping address and the at least one customer whose at least one provisional order has been combined with the provisional order from the customer at the shipping address that the provisional orders have been combined.

11. The method of claim 1, in which the step of the merchant computer searching for provisional orders from other customers comprises comparing location information about the shipping address for the customer at the shipping address to location information for the shipping address for the at least one provisional order from at least one other customer, and considering a provisional order to be eligible for combination if the comparison of the location information meets a selected proximity criterion.

12. The method of claim 11, in which the proximity criterion comprises a radial distance between the shipping address of the customer and the shipping address of the at least one provisional order from at least one other customer.

13. The method of claim 11, in which the proximity criterion comprises the shipping address of the customer and the shipping address of the at least one provisional order from at least one other customer being in the same ZIP code.

14. The method of claim 11, in which the proximity criterion comprises the shipping address of the customer and the shipping address of the at least one provisional order from at least one other customer being within a radial distance from a location of a central shipping point.
